(19) United States
(12) Patent Application Publication
(10) Pub. No.: US 2022/0147663 A1
(43) Pub. Date: May 12, 2022

(54) Simulation Value Calculating Method and Simulation Value Calculating Device

(71) Applicant: Nippon Telegraph and Telephone Corporation, Tokyo (JP)

(72) Inventors: Masahiro Sotoma, Musashino-shi, Tokyo (JP); Takuya Kamisho, Musashino-shi, Tokyo (JP); Masayuki Tsuda, Musashino-shi, Tokyo (JP)

(21) Appl. No.: 17/433,417

(22) PCT Filed: Mar. 13, 2020
(86) PCT No.: PCT/JP2020/010998

§ 371 Date: Aug. 24, 2021

(30) Foreign Application Priority Data
Mar. 29, 2019 (JP) 2019-066941

(51) Int. Cl. G06F 30/20; G06F 17/15

(52) U.S. Cl. CPC G06F 30/20; G06F 2111/10; G06F 17/15

(57) ABSTRACT

The accuracy in simulation values of environmental elements is improved. A simulation value calculation device includes: a simulation copula calculation unit that calculates simulation values of a plurality of environmental elements in an actual environment by using a predetermined copula function indicating a correlation between marginal distributions of the plurality of environmental elements; a simulation value calculation unit; and a data recording unit that stores the simulation values.

### TECHNICAL FIELD

The present invention relates to a technique for simulating an environmental element in an actual environment with a computer.

### BACKGROUND ART

At the time of elucidating mechanisms of degradation that occurs in substances, facilities, and the like existing in an actual environment and at the time of predicting the degradation, a simulated environment may be constructed by artificially simulating and reproducing, in a virtual environment, environmental elements involved in the degradation of the facilities and the like or environmental elements expected to be involved in the degradation, and then, an experiment, a simulation, or the like may be performed.

### CITATION LIST

### Patent Literature

Patent Literature 1: Japanese Patent Laid-Open No. 2003-242344

### Non-Patent Literature

Non-Patent Literature 1: “Special Issue, Copulas: New Perspective on Credit Risk Management,

Copulas: Theory and modeling,” Tsukahara, Securities Analysts Journal, Vol. 52, No. 3, March 2014, p.23-p.32

Non-Patent Literature 2: “Special Issue, Copulas: New Perspective on Credit Risk Management, Overview,” Morihira, Securities Analysts Journal, Vol. 52, No. 3, March 2014, p.2-p.9.

Non-Patent Literature 3: “Explanation of Specific Ways to Use Copula in financial Practice,” Tosaka and one other, Financial Research, Vol. 24, Supplement 2, December 2005, p.115-p.162

### SUMMARY OF THE INVENTION

### Technical Problem

In general, the environmental elements (e.g., temperature, humidity, CO₂ concentration, etc.) in the actual environment are not independent of each other but have an interdependent relation. Thus, in a case where a simulated environment is constructed using a plurality of environmental elements, how to simulate the interdependence among the environmental elements becomes a problem. Further, in a case where variation in environmental element (e.g., a change in temperature, etc.) is also simulated, how to set the range of the value of the environmental element in the simulated environment also becomes a problem.

Meanwhile, in technical fields such as statistics and probability theory, as a method for describing a joint distribution of a plurality of elements, a method using a copula has recently been proposed in addition to the conventional method assuming a multivariate normal distribution. The copula serves to join a joint distribution of a combination of a plurality of elements (a combination of random variables) and a distribution (marginal distribution) of each element constituting the joint distribution in a numerical analysis field, and a copula function is called a junction distribution function (Non-Patent Literature 1).

However, in order to estimate the risk of financial instruments (Patent Literature 1, Non-Patent Literature 2) and to select data by a comparison with the degree of interdependence (Non-Patent Literature 3), the copula has been applied to solve a robust optimization problem by using a sample generated from the copula and has not been used to solve the above problems that occur at the time of simulating the actual environment.

The present invention has been made in view of the above circumstances, and it is an object of the present invention to improve the simulation accuracy in environmental elements.

### Means for Solving the Problem

In order to solve the above problems, a simulation value calculation method of the present invention, which is performed by a simulation value calculation device, includes: a first step of calculating simulation values of a plurality of environmental elements in an actual environment by using a predetermined copula function indicating a correlation between marginal distributions of the plurality of environmental elements; and a second step of storing the simulation values into a storage unit.

In the above simulation value calculation method, in the first step, a degree of correlation between the marginal distributions is changed to calculate simulation values of the plurality of environmental elements.

In the above simulation value calculation method, in the first step, a simulation value within a predetermined range is extracted from the simulation values.

A simulation value calculation device according to the present invention includes: an arithmetic unit that calculates simulation values of a plurality of environmental elements in an actual environment by using a predetermined copula function indicating a correlation between marginal distributions of the plurality of environmental elements; and a storage unit that stores the simulation values.

### Effects of the Invention

According to the present invention, the simulation accuracy in environmental elements can be improved.

### BRIEF DESCRIPTION OF DRAWINGS

FIG. 1 is a diagram showing a functional block configuration of a simulation value calculation device.

FIG. 2 is a diagram showing a joint distribution of temperature and SO₂ concentration for 365 days.

FIG. 3 is a diagram showing a joint distribution of each uniform distribution calculated from the joint distribution of FIG. 2.

FIG. 4 is a diagram showing an example of simulation copulas.

FIG. 5 is a diagram showing a joint distribution of FIG. 3 and FIG. 4 superimposed.

FIG. 6 is a diagram showing a joint distribution of simulation values.

FIG. 7 is a diagram showing a joint distribution with FIGS. 2 and 6 superimposed.

FIG. 8 is a diagram showing simulation copulas and simulation values at t=0.2 and θ=1.25.

FIG. 9 is a diagram showing simulation copulas and simulation values at t=0.35 and θ=1.54.

FIG. 10 is a diagram showing simulation copulas and simulation values at t=0.4 and θ=1.67.

FIG. 11 is a diagram showing simulation copulas and simulation values at t=0.6 and θ=2.5.

FIG. 12 is a diagram showing simulation copulas and simulation values at t=0.8 and θ=5.0.

FIG. 13 is a diagram showing an example of extraction of simulation values within a predetermined range.

FIG. 14 is a diagram showing a processing flow of a simulation value calculation method.

### DESCRIPTION OF EMBODIMENTS

Hereinafter, an embodiment of the present invention will be described with reference to the drawings.

### Overview of Embodiment

As has already been described as a problem, it has been desired to research and develop a technology for setting a range of values of environmental elements, while maintaining the interdependence between the environmental elements, in accordance with a purpose of an experiment, limitations of a device that maintains a simulated environment, and the like.

Therefore, in the present embodiment, the environmental elements existing in the actual environment are simulated with a computer by using the copula described above. The copula serves to join a joint distribution of a plurality of elements and a distribution (marginal distribution) of each element constituting the joint distribution and shows the interdependence between the marginal distributions (between the elements) (a correlation between the marginal distributions).

The advantage of using the copula is that it is possible to model a complex actual environment with high accuracy by using the copula at the time of simulating the actual environment because the marginal distribution and the copula can be expressed separately. In addition, the normality of the marginal distribution is not assumed, or the interdependence between the elements is not uniformly evaluated based on the linear relationship of the whole distribution, so that it is suitable for describing the non-normality of the environmental elements existing in the actual environment and the non-linearity of the interdependence. In view of these advantages, in the present embodiment, an environmental element existing in an actual environment is treated as an element (variable) of a copula, and a simulation is performed using the copula having the environmental element as an element.

Specifically, the simulation is performed by using a copula to describe the interdependence between the environmental elements in the actual environment, that is, by using a copula capable of maintaining the interdependence between the marginal distributions in the actual environment. Thereby, the structure of the interdependence between the environmental elements can be maintained, and the environmental elements for use in the simulated environment can be simulated with values close to those in the actual environment.

The simulation is performed by using the copula to change the strength of the interdependence between the environmental elements used in the simulated environment, that is, by performing an operation for changing the parameters of the copula. Thus, while the structure of the interdependence between the environmental elements is maintained, the simulation value of the environmental element can be output with the range thereof arbitrarily changed in accordance with a purpose and contents of an experiment or the like performed under the simulated environment.

That is, according to the present embodiment, it is possible to construct a simulated environment that more faithfully reflects the actual environment. In addition, the range of the simulation value of the environmental element can be set in accordance with the purpose and contents of the experiment or the like performed under the simulated environment. These effects can improve the accuracy and efficiency in experiment, simulation, and the like.

### Theoretical Overview of Copula

First, the theoretical overview of the copula will be described. As described in non-Patent Literatures 1 to 3, the basic theory of the copula is developed in accordance with the Sklar's theorem shown in Expression (1). Assuming that F is an arbitrary d-dimensional joint distribution function and that an element (variable) of each element in the d-dimension is xᵢ (i=1, . . . , d), there exists a d-dimensional function C satisfying Expression (1).

### Math. 1

F(x₁, . . . x_{d})=C(F₁(x₁), . . . F_{d}(x_{d})) (1)

The function C is a copula function. Here, Fᵢ(i=1, . . . , d) is an i-th one-dimensional marginal distribution function of the d-dimensional joint distribution function F and is a uniform distribution function of an interval [0, 1]. In particular, when the d-dimensional joint distribution function F is continuous, the copula function C is uniquely determined and becomes a junction distribution function of the d-dimensional joint distribution function F. In this case, the copula function C is given using any uᵢ(i=1, . . . , d) (uᵢ ∈ [0, 1]) as shown in Expression (2). Note that Fᵢ⁻¹ is an inverse function of the marginal distribution function Fᵢ.

### Math. 2

C(u₁, . . . , u_{d})=F(F₁⁻¹(u₁), . . . , F_{d}⁻¹(u_{d})) (2)

That is, the copula function C is given by the marginal distribution function Fᵢ and the inverse function Fᵢ⁻¹ of the marginal distribution function Fᵢ from Expressions (1) and (2). Since being given by the marginal distribution function Fi, the copula function C is a function connecting the uniform distributions (marginal distributions). That is, the copula function C can be said to be a function indicating “correlation” and “relationship” among the marginal distribution functions Fᵢ, even though the information of the original marginal distribution is lost.

Note that Kendall's rank correlation coefficient τ is used as an index representing the strength of the “correlation” and “relationship” among the marginal distribution functions Fᵢ of the copula function C, that is, the strength of the interdependence between the marginal distributions (the degree of correlation among the marginal distributions). The Kendall's rank correlation coefficient t takes a value between “−1” and “1,” and an increase in the value means strong interdependence. The coefficient shows “0” when the rankings are completely independent, and shows “−1” when the rankings do not match completely.

Further, several types of the copula function C are shown, and there are a two-dimensional copula function and a multidimensional copula function of three dimensions or more. Each copula function C has a parameter θ, and the distribution state of the marginal distribution is changed in accordance with the parameter θ. The number of parameters θ depends on the type of the copula function C. The parameter θ of each copula function C and the Kendall's rank correlation coefficient τ have a predetermined relation.

### Computer Configuration]

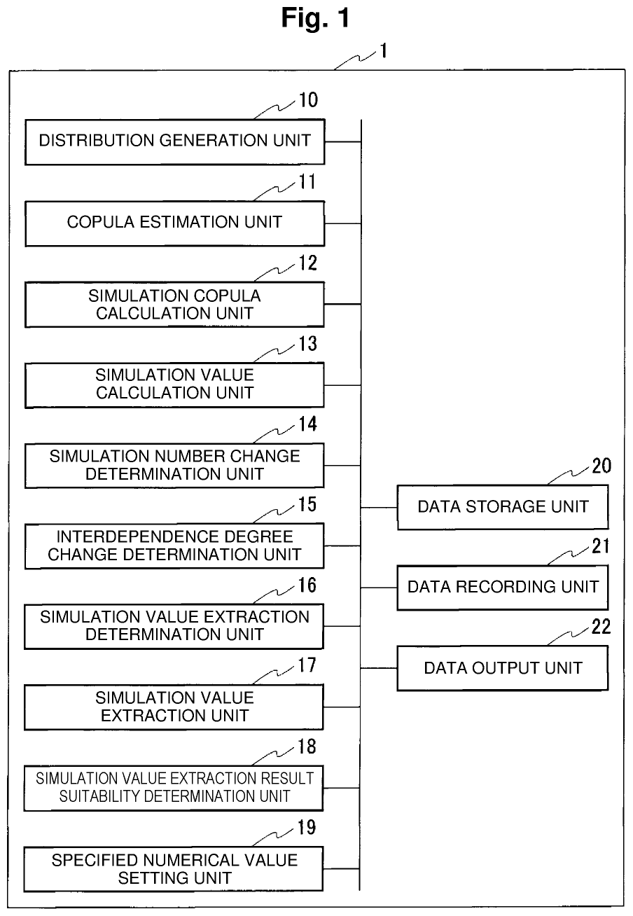

Next, a configuration of a computer (hereinafter, simulation value calculation device) used in the present embodiment will be described. FIG. 1 is a diagram showing a functional block configuration of a simulation value calculation device 1 according to the present embodiment.

The simulation value calculation device 1 is mainly provided with a distribution generation unit 10, a copula estimation unit 11, a simulation copula calculation unit 12, a simulation value calculation unit 13, a simulation number change determination unit 14, an interdependence degree change determination unit 15, a simulation value extraction determination unit 16, a simulation value extraction unit 17, a simulation value extraction result suitability determination unit 18, a specified numerical value setting unit 19, a data storage unit 20, a data recording unit 21, and a data output unit 22.

The distribution generation unit 10 has a function of reading measured value data relating to a plurality of environmental elements existing in the actual environment from the data storage unit 20 and generating a joint distribution of the plurality of environmental elements.

The copula estimation unit 11 has a function of calculating a value, obtained by using “the joint distribution of the plurality of environmental elements” to uniformly distribute the marginal distributions of the joint distribution, and generating a joint distribution of the uniform distribution of each marginal distribution of the joint distribution by using the calculated value. The copula estimation unit 11 has a function of estimating and calculating a copula function C, a parameter θ, and a Kendall's rank correlation coefficient t that most closely match “the joint distribution of the uniform distribution of each marginal distribution of the joint distribution” based on predetermined reference information.

The simulation copula calculation unit (arithmetic unit) 12 has a function of simulating a joint distribution corresponding to “the joint distribution of the uniform distribution of each marginal distribution of the joint distribution” generated from measured value data by using the copula function C, the parameter θ, and the Kendall's rank correlation coefficient t estimated and calculated by the copula estimation unit 11, and outputting the result as simulation copulas.

The simulation value calculation unit (arithmetic unit) 13 has a function of calculating a simulation value of a joint distribution corresponding to “the joint distribution of the plurality of environmental elements” generated from the measured value data by using the simulation copula output from the simulation copula calculation unit 12.

The simulation number change determination unit 14 has a function of determining whether or not to change the number of simulation copulas based on the presence or absence of a change instruction for the number of simulation copulas by a user (hereinafter, the user) using the simulation value calculation device 1 or based on some other condition.

The interdependence degree change determination unit 15 has a function of determining whether or not to change the Kendall's rank correlation coefficient τ, which is an index representing the strength of the interdependence between the marginal distributions of the plurality of environmental elements (the degree of correlation between the marginal distributions), based on the presence or absence of a change instruction by the user or based on some other condition.

The simulation value extraction determination unit 16 has a function of determining whether or not to extract the simulation value calculated by the simulation value calculation unit 13 as the final simulation result to a data recording unit 21 and a data output unit 22 based on the presence or absence of an extraction order by the user or based on some other condition.

The simulation value extraction unit 17 has a function of extracting all or some of the simulation values calculated by the simulation value calculation unit 13 to the data recording unit 21 and the data output unit 22 based on an extraction order by the user, an extraction range, or the like.

The simulation value extraction result suitability determination unit 18 has a function of determining whether or not the simulation value extracted by the simulation value extraction unit 17 is a simulation value within a range desired by the user based on a suitability order of the extraction result by the user, or the like.

The specified numerical value setting unit 19 has a function of recording and setting a specified numerical value (e.g., number of simulation copulas, etc.), which is used by the simulation value calculation device 1 during calculation processing for a simulation value, in the data recording unit 21 based on input setting by the user, or the like.

The data storage unit 20 is data to be analyzed and is a database for storing measured value data relating to a plurality of environmental elements existing in the actual environment.

The data recording unit (storage unit) 21 is a memory, hard disk, or the like which records (stores) a specified numerical value used by the simulation value calculation device 1 during calculation processing for a simulation value, a variable value during the calculation processing, a simulation value which is the final simulation result, and the like.

The data output unit 22 is a display for displaying the specified numerical value used by the simulation value calculation device 1 during the calculation processing for the simulation value, the variable value during the calculation processing, the simulation value which is the final simulation result, and the like, the data output unit 22 being an interface for outputting those values to a recording medium, such as a compact disc read-only memory (CD-ROM), the Internet, or the like.

It is possible to achieve the simulation value calculation device 1 described above by using a computer provided with a central processing unit (CPU), a memory, an input/output interface, a communication interface, and the like. It is also possible to create a program for causing the computer to function as the simulation value calculation device 1 and a storage medium for the program.

### Specific Example of Simulation

Next, a calculation method for a simulation value will be described with a specific example.

In order to clarify a degradation mechanism of a facility S installed outdoors in an area A, it is considered to construct a simulated environment obtained by simulating the outdoor environment in the area A. Temperature and a concentration of sulfur dioxide (SO₂) are taken up as environmental elements that affect the degradation of the facility S, and a simulated environment is constructed using these two environmental elements.

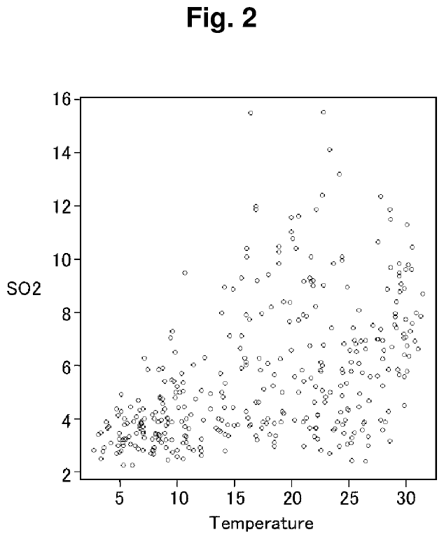

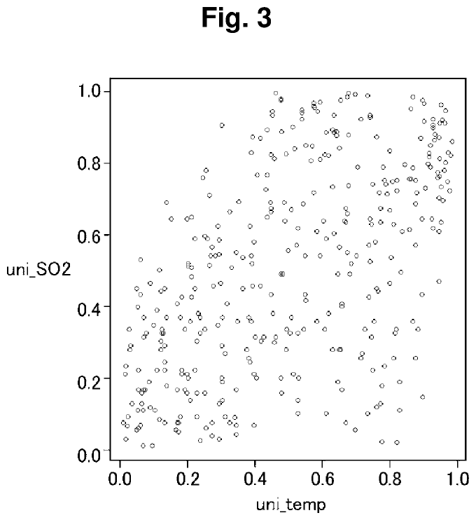

First, a joint distribution is generated for measured value data (for 356 days) of a daily average temperature (degrees) and a daily average SO₂ concentration (PPB) in the area A for each day over a year. FIG. 2 shows the joint distribution. Further, a joint distribution of a uniform distribution of each marginal distribution of the joint distribution is generated. FIG. 3 shows the joint distribution. Each marginal distribution is a marginal distribution relating to each of the temperature and SO₂ concentration, and each marginal distribution is a uniform distribution as described above.

Next, the copula function C, the parameter θ, and the Kendall's rank correlation coefficient τ, which most closely match “the joint distribution of the uniform distribution of each marginal distribution” shown in FIG. 3, are estimated. As a method for the estimation, the conventional estimation method is used. The estimation is performed based on, for example, the Akaike's information criterion (AIC), the Bayesian information criterion (BIC), or the like. In the case of parametric estimation, a copula function C, which most closely matches among a plurality of copula functions C proposed at present in the numerical analysis field, is estimated.

For example, “Survival Gumbel Copula” is estimated as the copula function C. Also, “1.54” is estimated as the parameter θ, and “0.35” is estimated as the Kendall's rank correlation coefficient τ. “Survival Gumbel Copula” is the copula function C obtained by rotating a Gumbel copula function shown in Expression (3) by 180 degrees. u and v are variables corresponding to the temperature and SO₂ concentration, respectively.

### Math. 3

C(u, v)=exp(−[(−lnu)^{θ}+(−lnv)^{θ}]^{1/θ}) (1≤θ) (3)

At this time, the parameter θ and the Kendall's rank correlation coefficient τ have a relation shown in Expression (4), and θ is uniquely determined by estimating τ.

### Math. 4

θ=1/(1−τ) (4)

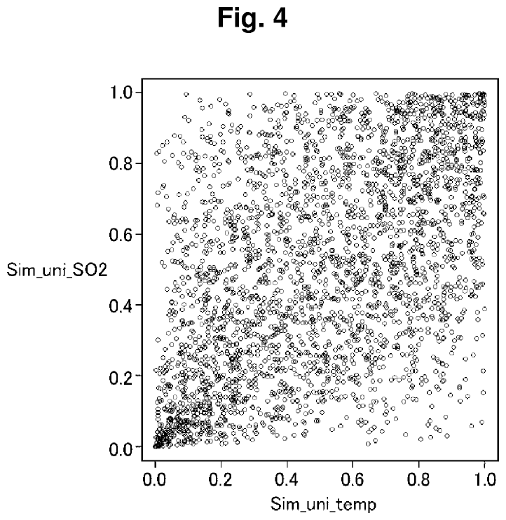

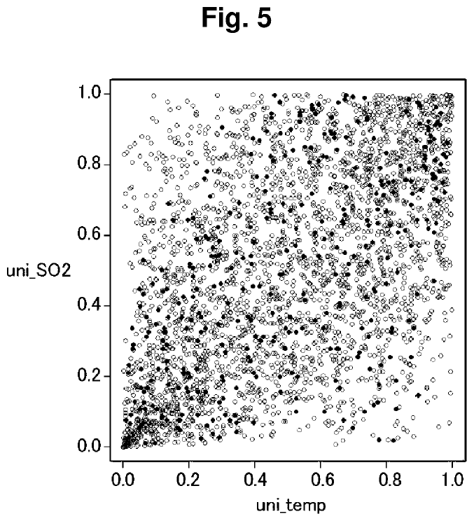

Next, a joint distribution corresponding to “the joint distribution of the uniform distribution of each marginal distribution” shown in FIG. 3 is simulated using the estimated copula function C and parameter θ. FIG. 4 shows the result of performing 3000 cases of simulations (hereinafter, simulation copulas). For reference, FIG. 5 shows a joint distribution in which the “simulation copulas” shown in FIG. 4 and “the joint distribution of the uniform distribution of each marginal distribution” shown in FIG. 3 are superimposed. In FIG. 5, white circles represent the “simulation copula,” and black circles represent “the joint distribution of the uniform distribution of each marginal distribution.” Note that the number of simulation copulas may be set in advance, the number set in advance may be selected, or the number may be set each time the output result to the display is confirmed.

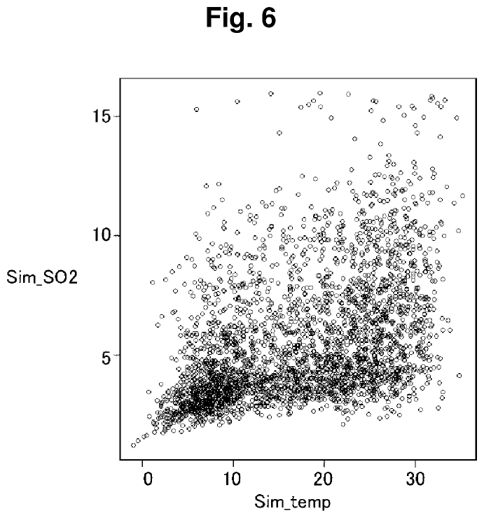

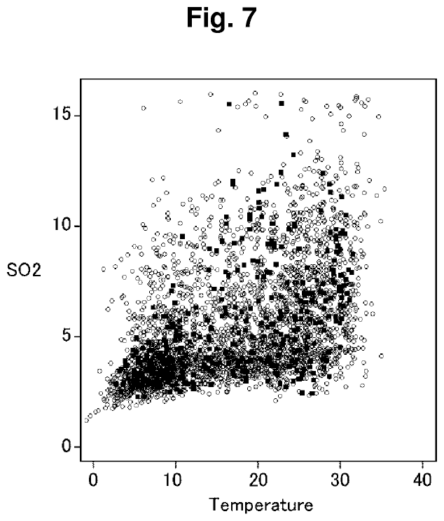

Finally, a joint distribution corresponding to “the joint distribution of the measured value data (for 356 days)” shown in FIG. 2 is simulated from the inverse function of the marginal distribution function of the marginal distribution by using the 3000 cases of simulation copulas. That is, the inverse function of the marginal distribution function of the marginal distribution is calculated using the 3000 cases of simulation copulas, to calculate 3000 cases of simulation values of each marginal distribution. FIG. 6 shows the joint distribution of the simulation values. For reference, FIG. 7 shows a joint distribution in which “the joint distribution of the simulation values” shown in FIG. 6 and “the joint distribution of the measured value data (for 356 days)” shown in FIG. 2 are superimposed. In FIG. 7, white circles represent the “the joint distribution of the simulation values,” and black circles represent “the joint distribution of the measured value data (for 356 days).”

The simulation values thus obtained are calculated using the copula function C indicating the interdependence between the marginal distributions (the correlation between the marginal distributions) as shown in Expression (3), so that the use of the simulation values in the simulated environment can construct a simulated environment maintaining the interdependence of the marginal distributions in the actual environment.

Here, the Kendall's rank correlation coefficient t is an index representing the strength of the interdependence between the marginal distributions (the degree of correlation between the marginal distributions), and a parameter θ corresponding to an arbitrary dependency strength can be derived from the relational expression shown in Expression (4). That is, by changing t and changing the parameter θ of the copula function C, the simulation value of the marginal distribution having the arbitrary dependency strength can be calculated.

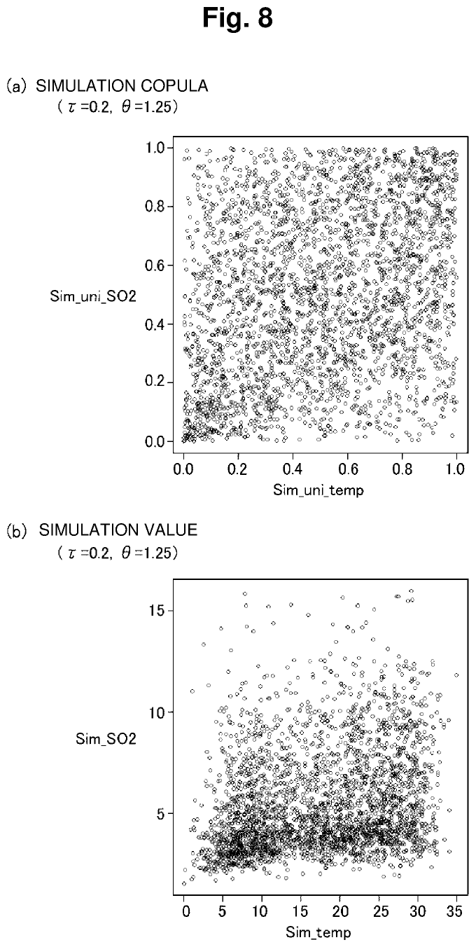

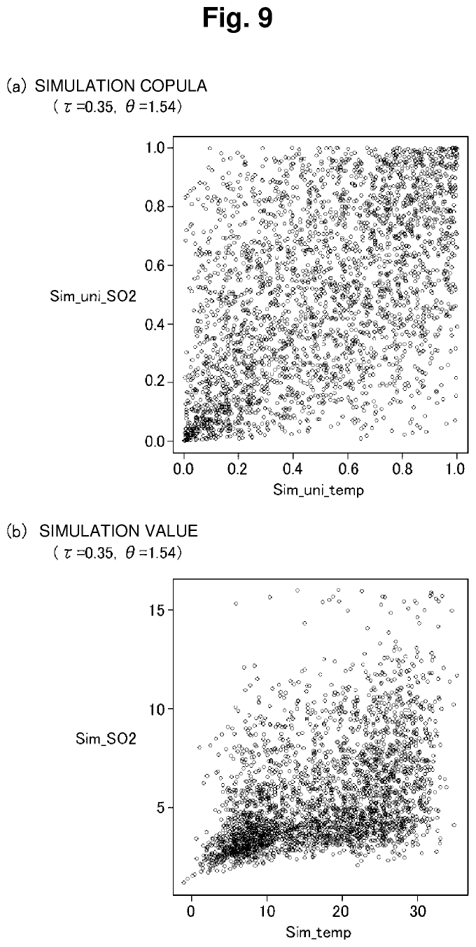

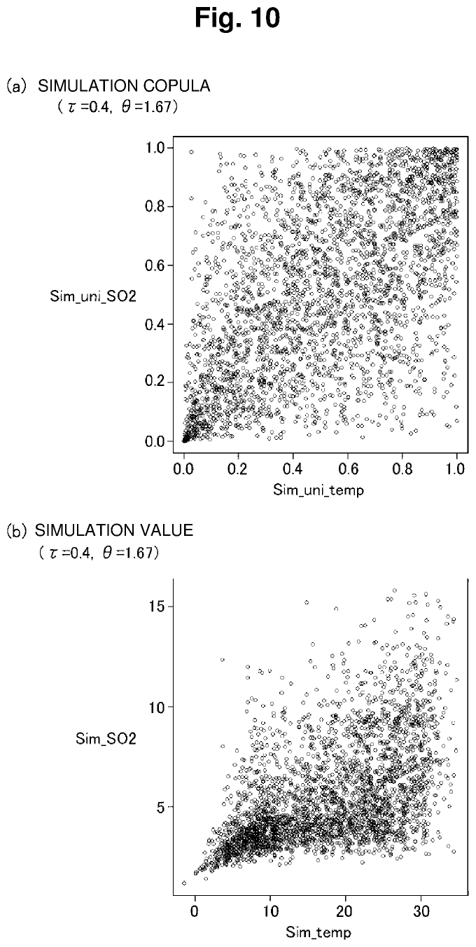

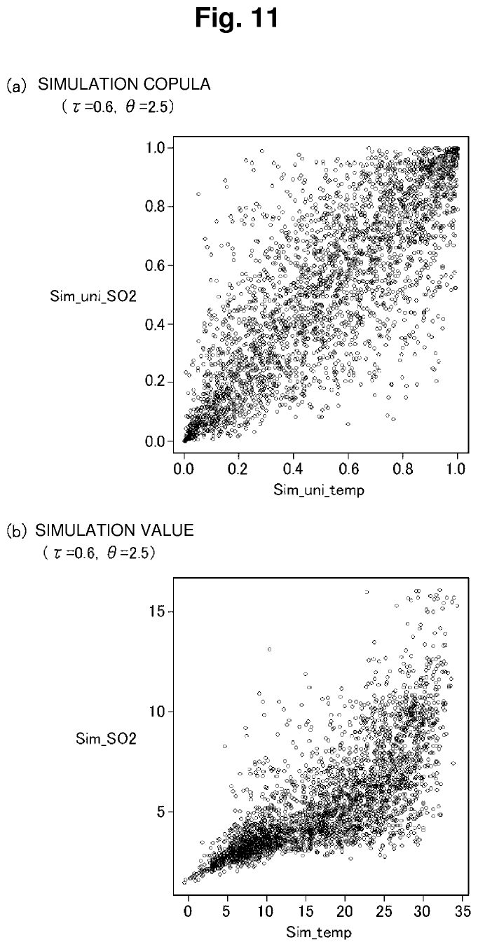

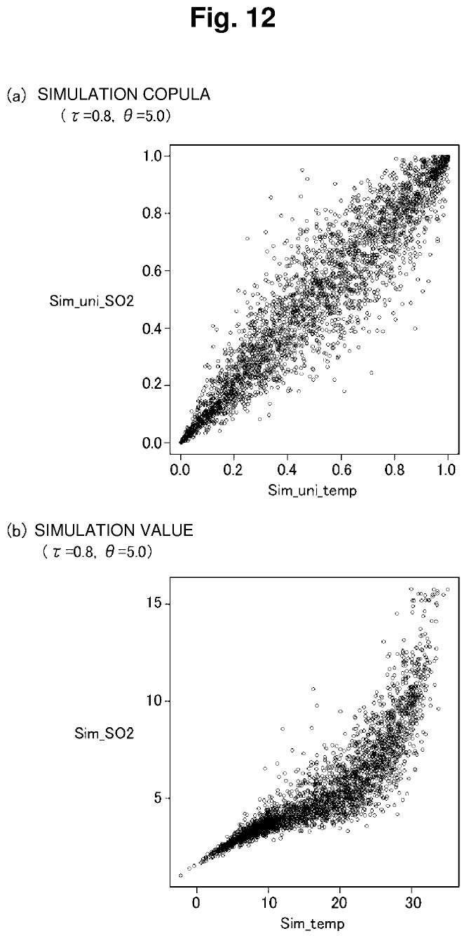

FIGS. 8 to 12 each shows 3000 cases of simulation copulas when t is changed within a range of 0.2 to 0.8, and simulation values calculated using the simulation copulas. It can be seen from FIGS. 8 to 12 that as τ and θ increase, the dispersion of the distribution state decreases, and the extent of the distribution state converges gradually.

As a result, by changing τ (or θ), it is possible to calculate simulation values having an arbitrary dispersion while maintaining the interdependence of the marginal distributions in the actual environment. For example, when it is desired to perform an experiment by narrowing the range of values of environmental elements in the simulated environment, it is conceivable to calculate simulation values having a specific dispersion in accordance with the capability and reliability of an environmental control apparatus that is used in the simulated environment. τ and θ used at that time may be set in advance, τ and θ set in advance may be selected, or τ and θ may be set each time the output result to the display is confirmed.

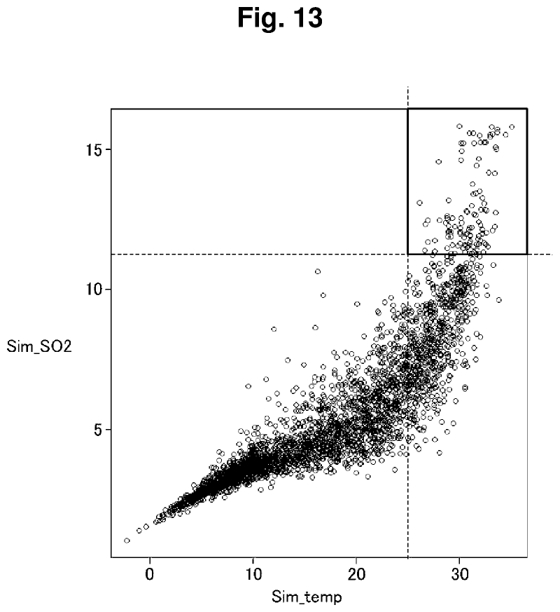

If necessary, only a partial range of the obtained simulation values can be extracted and used in the simulated environment. For example, in a case that when the higher the temperature and the higher the SO₂ concentration are, the more the degradation of the facility S is accelerated, it is conceivable to use only a range in which the temperature and SO₂ concentration of the simulation values are equal to or more than predetermined values, with the intention of simulating an environment in which the degradation is likely to occur. FIG. 13 shows an example of an extraction range satisfying conditions that the daily average temperature is 25 (degrees Celsius) or more and the daily average SO₂ concentration is 11 (PPB) or more. The range surrounded by a thick frame is a part of the extraction range. The threshold value of the extraction range may be set in advance, the threshold set in advance may be selected, or the threshold may be set each time the output result to the display is confirmed.

In the present specific example, the case where there are two environmental elements is taken up for convenience of description, but three or more environmental elements may be used. In a case where three or more environmental elements are handled, a multi-dimensional copula function of three or more dimensions may be used, or a vine copula for constructing a model by combining two environmental elements may be used. The processing of the present specific example can be utilized by any method.

### Processing Flow of Simulation Value Calculation Device

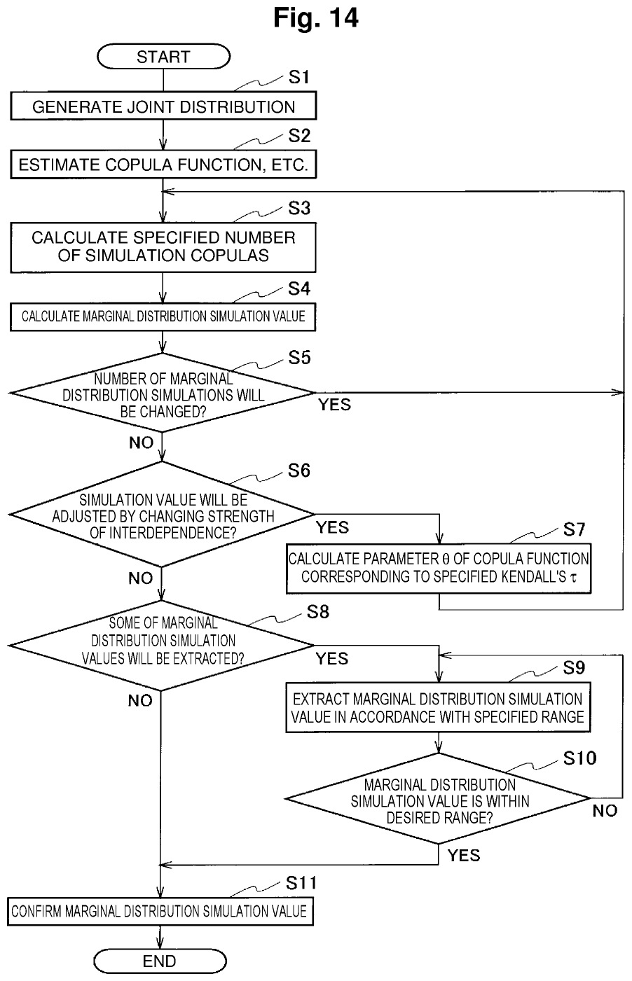

Next, a simulation value calculation method performed by the simulation value calculation device 1 will be described. FIG. 14 shows a processing flow of the simulation value calculation method.

### Step S1;

First, the distribution generation unit 10 reads measured value data relating to a plurality of environmental elements existing in the actual environment from the data storage unit 20 and generates a joint distribution of the plurality of environmental elements (FIG. 2).

### Step S2;

Next, the copula estimation unit 11 calculates a value, obtained by using “the joint distribution of the plurality of environmental elements” to uniformly distribute the marginal distributions of the joint distribution, and generates a joint distribution of the uniform distribution of each marginal distribution of the joint distribution (FIG. 3) by using the calculated value. Thereafter, the copula estimation unit 11 calculates a copula function C, a parameter θ, and a Kendall's rank correlation coefficient τ that most closely match “the joint distribution of the uniform distribution of each marginal distribution of the joint distribution” among a plurality of copula functions C proposed at present based on the Akaike's information criterion (AIC), the Bayesian information criterion (BIC), or the like.

### Step S3;

Next, the simulation copula calculation unit 12 simulates a joint distribution corresponding to “the joint distribution of the uniform distribution of each marginal distribution of the joint distribution” (FIG. 3) generated from measured value data by using the copula function C, the parameter θ, and the Kendall's rank correlation coefficient τ calculated in step S2, and calculates a specified number of simulation copulas (FIG. 4).

### Step S4;

Next, the simulation value calculation unit 13 calculates, from the inverse function of the marginal distribution function of the marginal distribution, a marginal distribution simulation value of the joint distribution corresponding to “joint distribution of a plurality of environmental elements” (FIG. 2) generated from the measured value data by using the simulation copula calculated in step S3 (FIG. 6).

### Step S5;

Next, the simulation number change determination unit 14 determines whether or not to change the number of simulation copulas of the marginal distribution calculated in step S4. Examples of a method for the determination includes a method of automatically determining whether or not the degree of dispersion matches between the initially given marginal distribution data and the marginal distribution simulation by using a standard deviation or the like. In addition, such a method is conceivable where the whole distribution of the marginal distribution simulation is divided by a grid, and it is automatically determined whether or not the number and density of points in the whole grid or a part of the grid satisfy preset numerical values and conditions. It is also conceivable that the user views the result displayed on the display or the like and sequentially makes the determination. When a change is to be made in the number of simulation copulas of the marginal distribution, the processing of the simulation value calculation device 1 returns to step S3 to perform recalculation with a new specified number. When no change is to be made, the processing of the simulation value calculation device 1 proceeds to step S6.

### Step S6;

When the number of simulation copulas of the marginal distribution is not to be changed, the interdependence degree change determination unit 15 determines whether or not to change the strength of the interdependence between the marginal distributions of the plurality of environmental elements (the degree of correlation between the marginal distributions) and adjust the marginal distribution simulation value calculated in step S4. As a method for the determination, for example, it is conceivable that a data range desired by the user is previously set as a marginal distribution simulation by using a standard deviation or the like, and the interdependence of the simulation copula is automatically changed so that a marginal distribution simulation within the data range is output. In addition, such a method is conceivable where the whole distribution of the marginal distribution simulation is divided by a grid, and it is automatically determined whether or not the number and density of points in the whole grid or a part of the grid satisfy preset numerical values and conditions. It is also conceivable that the user views the result displayed on the display or the like and sequentially makes the determination. When the marginal distribution simulation value is to be adjusted, the processing of the simulation value calculation device 1 proceeds to step S7. When no adjustment is to be made, the processing of the simulation value calculation device 1 proceeds to step S8.

### Step S7;

When the marginal distribution simulation value is to be adjusted, the copula estimation unit 11 calculates a parameter θby using the changed Kendall's rank correlation coefficient τ specified by the user. Thereafter, the processing of the simulation value calculation device 1 returns to step S3 to perform recalculation with a new parameter θ.

### Step S8;

When the marginal distribution simulation value is not to be changed, the simulation value extraction determination unit 16 determines whether or not to extract some of the marginal distribution simulation values calculated in step S4. As a method for the determination, for example, a method is conceivable where a threshold value and a range are set in advance for each marginal distribution, and a marginal distribution simulation value is automatically extracted based on the set threshold value and range. When no settings are made in advance, no extraction is performed. Alternatively, the user may sequentially make the settings while viewing the output result on the display or the like. When some of the marginal distribution simulation values are to be extracted, the processing of the simulation value calculation device 1 proceeds to step S9. When some of the marginal distribution simulation values are not to be extracted, the processing of the simulation value calculation device 1 proceeds to step S11.

### Step S9;

When some of the marginal distribution simulation values are to be extracted, the simulation value extraction unit 17 extracts the marginal distribution simulation value included in the specified range in accordance with the specified range specified by the user.

### Step S10;

After step S9, the simulation value extraction result suitability determination unit 18 determines whether or not the marginal distribution simulation value extracted in step S9 is a simulation value within a range desired by the user. As a method for the determination, for example, a method is conceivable where a threshold value and a range are set in advance for each marginal distribution, and it is automatically determined whether or not the marginal distribution simulation value extracted based on the set threshold value and range is as desired. The user may sequentially make the determination while viewing the output result on the display or the like. When the simulation value is within the desired range, the processing of the simulation value calculation device 1 proceeds to step S11. When the simulation value is not within the desired range, the processing of the simulation value calculation device 1 returns to step S9, and the simulation value extraction unit 17 extracts a simulation value in a new range.

### Step S11;

Finally, the simulation value extraction unit 17 extracts the marginal distribution simulation value, extracted in step S8 or step S10, as the final simulation result to the data recording unit 21 and the data output unit 22. Thereby, the marginal distribution simulation value is determined.

### Effect of Embodiment

As described above, according to the present embodiment, simulation values of a plurality of environmental elements are calculated using the copula function indicating the correlation between the marginal distributions of the plurality of environmental elements in the actual environment, so that the structure of the interdependence between the environmental elements can be maintained, and environmental elements for use in a simulated environment can be simulated with values close to those in the actual environment.

Further, according to the present embodiment, the simulation values of the plurality of environmental elements are calculated by changing the degree of correlation between the marginal distributions, whereby it is possible to arbitrarily change the range of the simulation values of the environmental elements in accordance with a purpose and content of an experiment or the like performed under a simulated environment, while maintaining the structure of the interdependence between the environmental elements.

As a result, the accuracy and efficiency of the experiment can be improved.

### REFERENCE SIGNS LIST

1 Simulation value calculation device
10 Distribution generation unit
11 Copula estimation unit
12 Simulation copula calculation unit
13 Simulation value calculation unit
14 Simulation number change determination unit
15 Interdependence degree change determination unit
16 Simulation value extraction determination unit
17 Simulation value extraction unit
18 Simulation value extraction result suitability determination unit
19 Specified numerical value setting unit
20 Data storage unit
21 Data recording unit
22 Data output unit

1. A simulation value calculation method performed by a simulation value calculation device, the method comprising:
a first step of calculating simulation values of a plurality of environmental elements in an actual environment by using a predetermined copula function indicating a correlation between marginal distributions of the plurality of environmental elements; and
a second step of storing the simulation values into a storage unit.

2. The simulation value calculation method according to claim 1, wherein in the first step, a degree of correlation between the marginal distributions is changed to calculate simulation values of the plurality of environmental elements.

3. The simulation value calculation method according to claim 1, wherein in the first step, a simulation value within a predetermined range is extracted from the simulation values.

4. A simulation value calculation device comprising:
an arithmetic unit that calculates simulation values of a plurality of environmental elements in an actual environment by using a predetermined copula function indicating a correlation between marginal distributions of the plurality of environmental elements; and
a storage unit that stores the simulation values.

5. The simulation value calculation method according to claim 2, wherein in the first step, a simulation value within a predetermined range is extracted from the simulation values.
